(19) United States
(12) Patent Application Publication
(10) Pub. No.: US 2023/0034022 A1
(43) Pub. Date: Feb. 2, 2023

(54) FLEXIBLE COMPUTING DISPLAYS WITH CONFIGURABLE SIZES

(71) Applicant: HEWLETT-PACKARD DEVELOPMENT COMPANY, L.P., Spring, TX (US)

(72) Inventors: Guoxing YANG, Spring, TX (US); Derek Kyle Joseph KANAS, Spring, TX (US); Christopher STEVEN, Spring, TX (US); Andre DA FONTE LOPES DA SILVA, Palo Alto, CA (US)

(73) Assignee: HEWLETT-PACKARD DEVELOPMENT COMPANY, L.P., Spring, TX (US)

(21) Appl. No.: 17/390,120

(22) Filed: Jul. 30, 2021

(51) Int. Cl. G06F 1/16; G06F 13/40; G06F 13/42

(52) U.S. Cl. CPC G06F 1/1652; G06F 1/1681; G06F 1/1679; G06F 1/1669; G06F 13/4068; G06F 13/4282; G06F 2213/0042

(57) ABSTRACT

Flexible computing displays with configurable sizes may include an apparatus comprising a flexible computing display and a display container having a form factor to contain the flexible computing display in a rolled state. The display container may further include circuitry to communicatively couple the flexible computing display with a computing device. The apparatus may further include a friction hinge mechanism coupling the display container and the flexible computing display, the friction hinge mechanism to enable a configurable size of the flexible computing display in an unrolled state by extension of the flexible computing display from the display container.

### BACKGROUND

Flexible displays are useful in allowing devices to be stored in a smaller space, like a pocket, while providing a screen size that is more enjoyable for the display of media. In flexible display devices, a plurality of pixels may be formed on a thin and flexible substrate such as plastic, and thus, even when the flexible display devices are folded or rolled up as in paper, the flexible display devices can display an image. Examples of such flexible display devices include flexible liquid crystal display devices, flexible plasma display devices, flexible organic light emitting display devices, flexible electrophoretic display devices, and flexible electro-wetting display devices, among others.

### BRIEF DESCRIPTION OF THE DRAWINGS

FIG. 1 illustrates an example flexible computing display with a configurable size, in accordance with the present disclosure.

FIG. 2 illustrates an example apparatus including a flexible computing display with a configurable size and dual form factors, in accordance with the present disclosure.

FIG. 3 illustrates a front view of an example apparatus including a flexible computing display with a configurable size, dual form factors and dual friction hinges, in accordance with the present disclosure.

FIG. 4 illustrates a rear view of an example apparatus including a flexible computing display with a configurable size, dual form factors and dual friction hinges, in accordance with the present disclosure.

FIG. 5 illustrates an example system including a flexible computing display with a configurable size, and a computing device in accordance with the present disclosure.

FIG. 6 illustrates an example system including a flexible computing display in a rolled state, in accordance with the present disclosure.

FIG. 7 illustrates a side view of an example apparatus including extendable bases, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Computing stations may include a laptop, a docking station, a full-size keyboard, dual monitors, a mouse, a headset, and a camera, among other components. Often times, users may have a full-size keyboard and large (such as 27″, 32″, or larger) dual monitors. Similarly, a laptop that is portable and compact enough to be suitable for travelling has a compact keyboard and a small (such as 17″, 15″, 13″ or smaller) display. With a smaller display size and perhaps with the use of a single computing display as opposed to dual display, users may be less productive. Many times, it may not be practical for a user to bring large dual monitors and a full-size keyboard along with the laptop when travelling. Moreover, laptops with external LCD/LED displays are not rollable and may have a size limit such as 17″.

Flexible computing displays with configurable sizes, in accordance with the present disclosure, allow for larger computing displays to be used with portable computing devices. In accordance with the present disclosure, flexible computing displays with configurable sizes include an example apparatus comprising a flexible computing display and a display container having a form factor to contain the flexible computing display in a rolled state. The display container further includes circuitry to communicatively couple the flexible computing display with a computing device. The apparatus further includes a friction hinge mechanism coupling the display container and the flexible computing display, the friction hinge mechanism to enable a configurable size of the flexible computing display in an unrolled state by extension of the flexible computing display from the display container.

Another non-limiting example of flexible computing displays with configurable sizes includes an apparatus comprising a flexible computing display including a first edge and a second edge, and a display container. The display container includes a first form factor disposed on the first edge of the flexible computing display and a second form factor disposed on the second edge of the flexible computing display. The display container may contain the flexible computing display in a rolled state and include circuitry to communicatively couple the flexible computing display with a computing device. The display container may include a first friction hinge mechanism disposed in the first form factor and a second friction hinge mechanism disposed in the second form factor, wherein the first friction hinge mechanism and the second friction hinge mechanism couple the display container and the flexible computing display, and enable a configurable size of the flexible computing display in an unrolled state by extension of the flexible computing display from the display container.

Another non-limiting example of flexible computing displays with configurable sizes includes a system, comprising a keyboard and a first display apparatus. In such examples, the keyboard includes a processor and a plurality of output ports, and a fastening mechanism to couple the keyboard to a display container. The first display apparatus may include a flexible computing display including a first edge and a second edge, and a display container having a first form factor disposed on the first edge of the flexible computing display and a second form factor disposed on the second edge of the flexible computing display. The display container may contain the flexible computing display in a rolled state. The display container may also include a first friction hinge mechanism disposed in the first form factor and a second friction hinge mechanism disposed in the second form factor, wherein the first friction hinge mechanism and the second friction hinge mechanism couple the display container and the flexible computing display, and enable a configurable size of the flexible computing display in an unrolled state by extension of the flexible computing display from the display container.

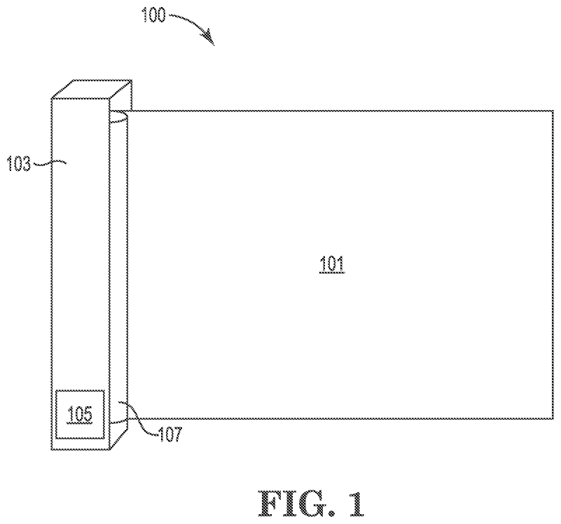

Turning now to the Figures, FIG. 1 illustrates an example flexible computing display with a configurable size, in accordance with the present disclosure. As illustrated in FIG. 1, an apparatus 100 in accordance with the present disclosure may include a flexible computing display. For instance, apparatus 100 may include flexible computing display 101. As used herein, a flexible display refers to or includes a visual output surface that is able to withstand being folded, bent and/or twisted. Non-limiting examples of a flexible computing display include a light emitting diode (LED), an organic light emitting diode (OLED), a liquid crystal display (LCD), a cathode ray tube display (CRT), a flexible electronic paper, and/or a touchscreen, among other non-limiting examples. In some examples, the flexible computing display is capable of extending from a display container, and of being enclosed within the display container, as discussed herein.

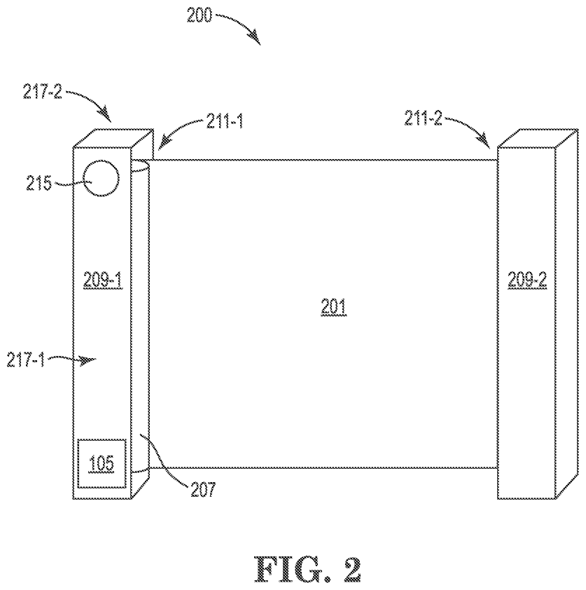

In various examples, the apparatus 100 includes a display container 103 having a form factor to contain the flexible computing display 101 in a rolled state, and including circuitry 105 to communicatively couple the flexible computing display 101 with a computing device. As used herein, a display container refers to or includes an apparatus including a plurality of components for storing and/or operating a flexible computing display. The display container 103 may include more or fewer components, as discussed further herein. As illustrated in FIG. 1, the form factor of the display container 103 may include a generally rectangular enclosure with an opening to permit passage of the flexible computing display 101. The display container 103 may include different and/or additional form factors, such as discussed and illustrated with regards to FIG. 2. For instance, the form factor may be tubular, oblong, square, or have any other shape sufficient for storage of the flexible computing display 101 in a rolled state. As used herein, a rolled state of the flexible computing display 101 refers to or includes a configuration of the flexible computing display 101 in which the flexible computing display 101 is rolled into a scroll-like shape, contained within the display container 103, and not extended from the display container 103. Similarly, an unrolled state of the flexible computing display 101 refers to or includes a configuration of the flexible computing display 101 in which the flexible computing display 101 is partially or fully extended from the display container 103.

In some examples, the display container 103 includes a fastening mechanism to couple the display container 103 to a surface of the computing device when the flexible computing display 101 is in the rolled state. As used herein, a fastening mechanism refers to or includes any structural components to connect and/or attach one physical object to another physical object. Non-limiting examples of fastening mechanisms that may be used to connect a display container to a surface of a computing device and/or to another display container, include a magnet, a latch, and a sliding hook, among others.

In some examples, the circuitry 105 to communicatively couple the flexible computing display 101 with the computing device includes a retractable cable. A non-limiting example of a retractable cable includes a universal serial bus type C (USB-C) connector.

In some examples, the apparatus 100 includes a friction hinge mechanism coupling the display container and the flexible computing display. For instance, the apparatus 100 includes a friction hinge mechanism 107 coupling the display container 103 and the flexible computing display 101. In various examples, the friction hinge mechanism enables a configurable size of the flexible computing display in an unrolled state by extension of the flexible computing display from the display container. For instance, the friction hinge mechanism 107 enables the flexible computing display 101 to move from a rolled state to an unrolled state by extension of the flexible computing display 101 from the display container. The friction hinge mechanism 107 allows for the flexible computing display 101 to be extended from the display container 103 by any amount up to the length of the flexible computing display 101. Due to the torque action of the friction hinge mechanism 107, the flexible computing display 101 may unroll to any configurable length up to the length of the flexible computing display 101. As used herein, a friction hinge mechanism refers to or includes a hinge that is capable of unrolling the flexible computing display and to stop and hold the flexible computing display 101 in place at any position. While they are referred to herein as a “friction hinge mechanism,” the hinge mechanism may also be referred to as a torque hinge and/or a free stop hinge. Additionally, while the hinge mechanism illustrated at 107 is referred to herein as a friction hinge (torque hinge, and/or free stop hinge), examples are not so limited, and any other hinge mechanism capable of rolling and unrolling the flexible computing display and which provides the ability to stop and hold the flexible computing display in place at any position may be used.

FIG. 2 illustrates an example apparatus including a flexible computing display with a configurable size and dual form factors, in accordance with the present disclosure. The apparatus 200 illustrated in FIG. 2 may be similar to apparatus 100 illustrated in FIG. 1, and similar components are numbered accordingly. For instance, flexible computing display 201 may be the same as or similar to flexible computing display 101, and friction hinge mechanism 207 may be the same as or similar to friction hinge mechanism 107.

Although FIG. 1 illustrates the display container 103 as including one form factor, the example illustrated in FIG. 2 includes two form factors 209-1 and 209-2, which collectively form the display container 209. As illustrated in FIG. 2, the display container includes a first form factor 209-1 disposed on a first edge 211-1 of the flexible computing display 201 and a second form factor 209-2 disposed on a second edge 211-2 of the flexible computing display 201. Similar to the flexible computing display 101, the display container 209 may contain the flexible computing display 201 in a rolled state, and may include circuitry to communicatively couple the flexible computing display with a computing device.

In some examples, the display container includes an auxiliary device integrated in a side wall of the display container. For instance, the display container 209 may include auxiliary device 215. As used herein, an auxiliary device refers to or includes a piece of hardware that may be connected to the computing device to provide an additional functionality. Non-limiting examples of an auxiliary device which may be included in the display container 209 may include a microphone, a speaker or a plurality of speakers, and a camera, among others.

When included, auxiliary devices may be included in a surface of the display container 209. Each form factor of the display container may include a first surface and a second surface, wherein the second surface is opposite of the first surface. For instance, form factor 209-1 may include first surface 217-1 and second surface 217-2. As illustrated in FIG. 2, the auxiliary device 215 may be disposed on surface 217-1 of form factor 209-1. As discussed and illustrated herein, the display container 209 may be communicatively coupled to a computing device by a retractable cable.

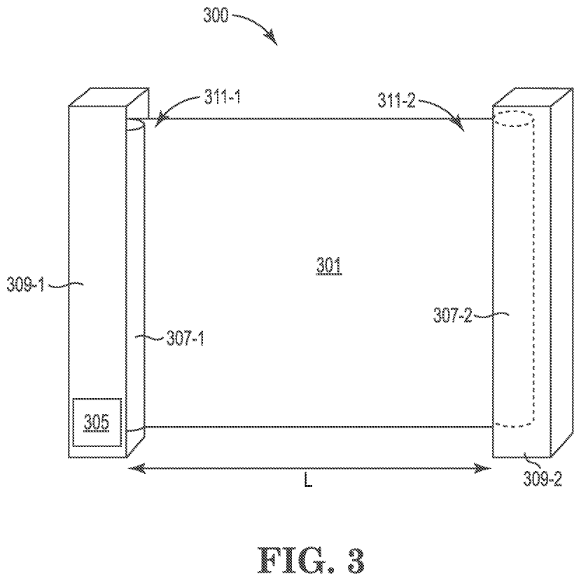

FIG. 3 illustrates a front view of an example apparatus including a flexible computing display with a configurable size, dual form factors and dual friction hinges, in accordance with the present disclosure. The apparatus 300 illustrated in FIG. 3 may be similar to apparatus 200 illustrated in FIG. 2, and apparatus 100 illustrated in FIG. 1, and similar components are numbered accordingly. For instance, flexible computing display 301 may be the same as or similar to flexible computing display 101, friction hinge mechanisms 307-1 and 307-2 may be the same as or similar to friction hinge mechanism 307, and circuitry 305 may be the same as or similar to circuitry 305.

Similar to the example illustrated and described with regards to FIG. 2, the example apparatus 300 illustrated in FIG. 3 includes a flexible computing display 301 including a first edge 311-1 and a second edge 311-2. In various examples, the apparatus 300 includes a display container having a first form factor disposed on the first edge of the flexible computing display and a second form factor disposed on the second edge of the flexible computing display. For instance, the apparatus 300 may include a first form factor 309-1 disposed on the first edge 311-1 of the flexible computing display 301 and a second form factor 309-2 disposed on the second edge 311-2 of the flexible computing display 301. Collectively, the first form factor 309-1 and the second form factor 309-2 comprise the display container 309.

As discussed herein, the display container may contain the flexible computing display in a rolled state and including circuitry to communicatively couple the flexible computing display with a computing device. For instance, the display container 309 may contain the flexible computing display 301 in a rolled state and including circuitry 305 to communicatively couple the flexible computing display 301 with a computing device. In some examples, the first form factor 309-1 is to contain a first portion of the flexible computing display 301 in the rolled state and the second form factor 309-2 is to contain a remainder of the flexible computing display 301 in the rolled state.

In some examples, the display container includes a first friction hinge mechanism disposed in the first form factor and a second friction hinge mechanism disposed in the second form factor. For instance, form factor 309-1 may include a friction hinge mechanism 307-1, and form factor 309-2 may include a friction hinge mechanism 307-2. As described herein, the first friction hinge mechanism and the second friction hinge mechanism couple the display container and the flexible computing display, and enable a configurable size of the flexible computing display in an unrolled state by extension of the flexible computing display from the display container. For instance, by pulling form factor 309-2 away from form factor 309-1 in the direction of L, the length L of the flexible computing display 301 may increase to any length selected by a user, until the flexible computing display 301 is no longer rolled in form factor 309-1 or form factor 309-2.

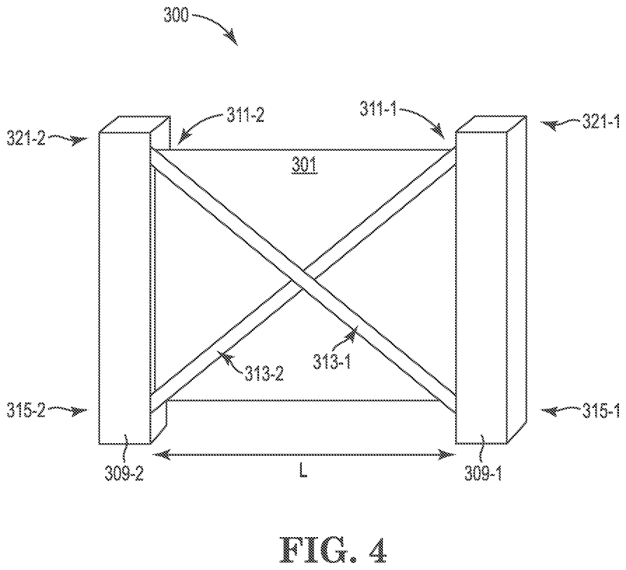

FIG. 4 illustrates a rear view of an example apparatus including a flexible computing display with a configurable size, dual form factors and dual friction hinges, in accordance with the present disclosure. The example illustrated in FIG. 4 is a rear view of apparatus 300 illustrated in FIG. 3. In the example illustrated in FIG. 4, the display container 309 includes a plurality of cross-sectional display guide rails 313-1 and 313-2 to support the flexible computing display 301 in the unrolled state. In various examples, a first guide rail 313-1 of the plurality of cross-sectional display guide rails is coupled to a bottom end 315-1 of the first form factor 309-1 and a top end 321-2 of the second form factor 309-2, and a second guide rail 313-2 of the plurality of cross-sectional display guide rails is coupled to a bottom end 315-2 of the second form factor 309-2 and a top end 321-1 of the first form factor 309-1. As the length L of the flexible computing display 301 may change based on an amount to which the first form factor 309-1 and the second form factor 309-2 are pulled apart from one another, the length R of the first guide rail 313-1 and the second guide rail 313-2 may change based on an amount to which the first form factor 309-1 and the second form factor 309-2 are pulled apart from one another.

In some examples, the display container 309 may include various fastening mechanisms. For instance, the first form factor 309-1 may include a first fastening mechanism to couple the display container 309 to a surface of a computing device and a second fastening mechanism to couple the first form factor 309-1 to the second form factor 309-2. Similarly, the second form factor 309-2 may include a first fastening mechanism to couple the display container 309 to the surface of a computing device and a second fastening mechanism to couple the second form 309-2 factor to the first form factor 309-1.

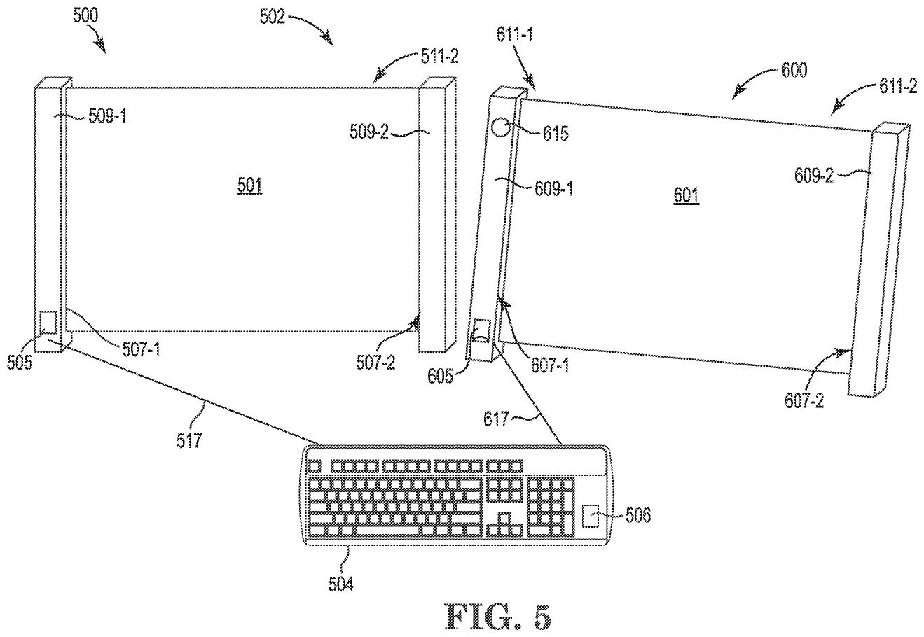

FIG. 5 illustrates an example system including a flexible computing display with a configurable size, and a computing device in accordance with the present disclosure. The apparatuses 500 and 600 illustrated in FIG. 5 may be similar to apparatus 200 illustrated in FIG. 2, and apparatus 100 illustrated in FIG. 1, and similar components are numbered accordingly. For instance, flexible computing displays 501 and 601 may be the same as or similar to flexible computing display 101, friction hinge mechanisms 507-1, 507-2, 607-1 and 607-2 may be the same as or similar to friction hinge mechanism 207 illustrated in FIG. 2 and hinge mechanism 107 illustrated in FIG. 1, and circuitry 505 and 605 may be the same as or similar to circuitry 2 illustrated in FIG. 2 and circuitry 105 illustrated in FIG. 1.

In various examples, a system in accordance with the present disclosure includes a keyboard including a processor and a plurality of output ports. For instance, system 502 includes a keyboard 504 which includes a processor 506 and a plurality of output ports. The keyboard 504 may include the processing capabilities of a personal computer and including ports such as USB, Ethernet, and HDMI, among others.

In some examples, the system includes a plurality of display devices. For instance, the system 502 may include a first display apparatus 500 including a flexible computing display 501 including a first edge 511-1 and a second edge 511-2. The display apparatus 500 may include a display container having a first form factor 509-1 disposed on the first edge 511-1 of the flexible computing display and a second form factor 509-2 disposed on the second edge 511-2 of the flexible computing display 501. Collectively, the first form factor 509-1 and the second form factor 509-2 are referred to herein as the display container 509. As discussed herein, the display container 509 may contain the flexible computing display 501 in a rolled state. The first display apparatus further includes a first friction hinge mechanism 507-1 disposed in the first form factor 509-1 and a second friction hinge mechanism 507-2 disposed in the second form factor 509-2. As discussed herein, the first friction hinge mechanism 507-1 and the second friction hinge mechanism 507-2 couple the display container 509 and the flexible computing display 501, and enable a configurable size of the flexible computing display 501 in an unrolled state by extension of the flexible computing display 501 from the display container 509.

As illustrated, the system 502 includes a second display apparatus 600 comprising a second flexible computing display 601 including a first edge 611-1 and a second edge 611-2. In some examples, the second display container includes a first form factor 609-1 disposed on the first edge 611-1 of the second flexible computing display 601 and a second form factor 609-2 disposed on the second edge 611-2 of the second flexible computing display 601. Collectively, the first form factor 609-1 and the second form factor 609-2 are referred to herein as the display container 609. Similar to the first display container 509, the second display container 609 may contain the second flexible computing display 601 in a rolled state. In some examples, the second display container 609 may include a first friction hinge mechanism 607-1 disposed in the first form factor 609-1 of the second display container and a second friction hinge mechanism 607-2 disposed in the second form factor 609-2 of the second display container. The first friction hinge mechanism 607-1 and the second friction hinge mechanism 607-2 may couple the second display container 609 and the second flexible computing display 601, and enable a configurable size of the second flexible computing display 601 in an unrolled state by extension of the second flexible computing display 601 from the second display container 609. As discussed with regards to FIG. 2, the first display container 509 or the second display container 609 may include an auxiliary device. For instance, the second display container 609 is illustrated in FIG. 5 as including auxiliary device 615.

In some examples, the keyboard is communicatively coupled to the display apparatus by a retractable cable. For instance, display container 509 may be coupled to the keyboard by retractable cable 517, and display container 609 may be coupled to the keyboard by retractable cable 617. A non-limiting example of a retractable cable may include a USB-C cable. The retractable cable (e.g., 517 and 617) may be retractable into each respective display container (e.g., 509 and 609, respectively), and/or into the keyboard 504.

Each of apparatus 500 and apparatus 600 may compress into a rolled state and stored with the keyboard 504 in a compact arrangement for travel and storage. By providing processing capabilities in the keyboard 504, and by providing a flexible computing display with a configurable size which can roll into the display container for storage and transport, a system 502 as illustrated in FIG. 5 when closed, may fit in a backpack or sleeve. When in an unrolled state, the system 502 may provide a configurable display screen (501 and/or 601) capable of conforming to multiple sizes and also capable of being arranged in a dual-screen configuration for increased usability.

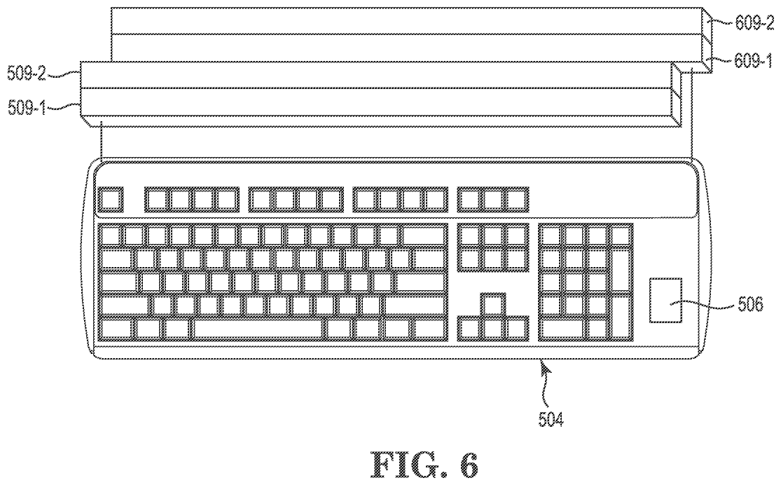

FIG. 6 illustrates an example system including a flexible computing display in a rolled state, in accordance with the present disclosure. The system 502 illustrated in FIG. 6 is the same system 502 illustrated in FIG. 5, but in which the apparatuses 500 and 600 are in the rolled state. As illustrated in FIG. 6, each flexible display may be rolled within the respective display container (e.g., 509 and 609). In various examples, the keyboard 504 includes a fastening mechanism to couple the keyboard 504 to a display container. For instance, the first form factor 509-1 of the first display apparatus 500 includes a first fastening mechanism to couple the first display apparatus 500 to the fastening mechanism of the keyboard 504, and the second form factor 509-2 of the first display apparatus 500 includes a second fastening mechanism to couple the second form factor 509-2 to the second display apparatus 600. The second display apparatus 600 may also include fastening mechanisms to couple display apparatuses to one another and/or to the keyboard. For instance, the first form factor 609-1 of the second display apparatus 600 includes a first fastening mechanism to couple the second display apparatus 600 to the fastening mechanism of the first display apparatus 500, and the second form factor 609-2 of the first display apparatus 600 includes a second fastening mechanism to couple the second form factor 609-2 to another display apparatus (not illustrated) and/or to the keyboard 504. In various examples, the fastening mechanism to couple one display apparatus to another display apparatus may be the same as the fastening mechanism to couple the display apparatus to the keyboard. Non-limiting examples of fastening mechanisms that may be used to connect a display container to a surface of a computing device and/or to another display container, include a magnet, a latch, and a sliding hook, among others. In some examples, different surfaces of a form factor may include a fastening mechanism. For instance, form factor 509-1 may include a fastening mechanism on one surface to couple the form factor 509-1 to the keyboard 504, and an opposing surface of form factor 509-1 may include a fastening mechanism to couple the form factor 509-1 to the first form factor 609-1 of the second display apparatus. In such a manner, systems in which display apparatuses include one form factor instead of two form factors may allow for display containers to be coupled to one another and/or to the keyboard 504.

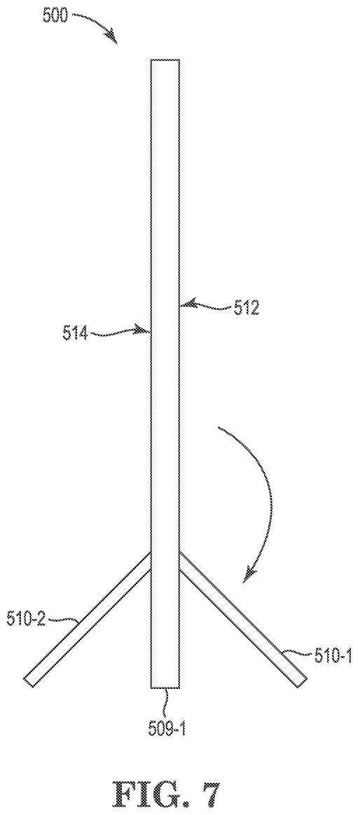

FIG. 7 illustrates a side view of an example apparatus including extendable bases, in accordance with the present disclosure. The apparatus 500 illustrated in FIG. 7 is the same apparatus 500 illustrated in FIG. 5, but from a side perspective. In some examples, the first form factor and the second form factor include a plurality of extendable bases to maintain the display apparatus in an upright position. For instance, as illustrated in FIG. 7, the first form factor 509-1 may include a first extendable base 510-1 and a second extendable base 510-2. The first extendable base 510-1 may flip downwards in the direction of the arrow away from a face 512 of the flexible computing display 501. The second extendable base 510-2 may flip downwards in the direction of the arrow away from a back 514 of the flexible computing display 501. The second flexible computing display (not illustrated in FIG. 7) may also include a plurality of extendable bases to maintain the second flexible computing display in an upright position.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. An apparatus, comprising:
a flexible computing display;
a display container having a form factor to contain the flexible computing display in a rolled state, and including circuitry to communicatively couple the flexible computing display with a computing device; and
a friction hinge mechanism coupling the display container and the flexible computing display, the friction hinge mechanism to enable a configurable size of the flexible computing display in an unrolled state by extension of the flexible computing display from the display container.

2. The apparatus of claim 1, wherein the display container includes a fastening mechanism to couple the display container to a surface of the computing device when the flexible computing display is in the rolled state.

3. The apparatus of claim 1, wherein the circuitry to communicatively couple the flexible computing display with the computing device includes a retractable universal serial bus type C (USB-C) connector.

4. The apparatus of claim 1, wherein the display container includes an auxiliary device integrated in a side wall of the display container.

5. The apparatus of claim 1, wherein the display container includes a first surface and a second surface, wherein the second surface is opposite of the first surface, and wherein the display container includes a first extendable base on the first surface and a second extendable base on the second surface.

6. An apparatus, comprising:
a flexible computing display including a first edge and a second edge;
a display container having a first form factor disposed on the first edge of the flexible computing display and a second form factor disposed on the second edge of the flexible computing display, the display container to contain the flexible computing display in a rolled state and including circuitry to communicatively couple the flexible computing display with a computing device; and
a first friction hinge mechanism disposed in the first form factor and a second friction hinge mechanism disposed in the second form factor, wherein the first friction hinge mechanism and the second friction hinge mechanism couple the display container and the flexible computing display, and enable a configurable size of the flexible computing display in an unrolled state by extension of the flexible computing display from the display container.

7. The apparatus of claim 6, wherein the first form factor is to contain a first portion of the flexible computing display in the rolled state and the second form factor is to contain a remainder of the flexible computing display in the rolled state.

8. The apparatus of claim 6, wherein the display container includes a plurality of cross-sectional display guide rails to support the flexible computing display in the unrolled state.

9. The apparatus of claim 8, wherein a first guide rail of the plurality of cross-sectional display guide rails is coupled to a bottom end of the first form factor and a top end of the second form factor, and wherein a second guide rail of the plurality of cross-sectional display guide rails is coupled to a bottom end of the second form factor and a top end of the first form factor.

10. The apparatus of claim 6, wherein:
the first form factor includes a first fastening mechanism to couple the display container to a surface of the computing device and a second fastening mechanism to couple the first form factor to the second form factor; and
the second form factor includes a first fastening mechanism to couple the display container to the surface of the computing device and a second fastening mechanism to couple the second form factor to the first form factor.

11. A system, comprising:
a keyboard including:
a processor and a plurality of output ports; and
a fastening mechanism to couple the keyboard to a display container; and
a first display apparatus including:
a flexible computing display including a first edge and a second edge;
a display container having a first form factor disposed on the first edge of the flexible computing display and a second form factor disposed on the second edge of the flexible computing display, the display container to contain the flexible computing display in a rolled state; and
a first friction hinge mechanism disposed in the first form factor and a second friction hinge mechanism disposed in the second form factor, wherein the first friction hinge mechanism and the second friction hinge mechanism couple the display container and the flexible computing display, and enable a configurable size of the flexible computing display in an unrolled state by extension of the flexible computing display from the display container.

12. The system of claim 11, wherein the keyboard is communicatively coupled to the display apparatus by a retractable universal serial bus type C (USB-C) connector.

13. The system of claim 11, wherein the first form factor and the second form factor include a plurality of extendable bases to maintain the display apparatus in an upright position.

14. The system of claim 11, including a second display apparatus comprising:
a second flexible computing display including a first edge and a second edge;
a second display container having a first form factor disposed on the first edge of the second flexible computing display and a second form factor disposed on the second edge of the second flexible computing display, the second display container to contain the second flexible computing display in a rolled state; and
a first friction hinge mechanism disposed in the first form factor of the second display container and a second friction hinge mechanism disposed in the second form factor of the second display container, wherein the first friction hinge mechanism and the second friction hinge mechanism couples the second display container and the second flexible computing display, and enable a configurable size of the second flexible computing display in an unrolled state by extension of the second flexible computing display from the second display container.

15. The system of claim 14, wherein:
the first form factor of the first display apparatus includes a first fastening mechanism to couple the first display apparatus to the fastening mechanism of the keyboard, and the second form factor of the first display apparatus includes a second fastening mechanism to couple the second form factor to the second display apparatus.
